(19) United States
(12) Patent Application Publication
(10) Pub. No.: US 2024/0020557 A1
(43) Pub. Date: Jan. 18, 2024

(54) ACTIVE LEARNING FOR HIGH-COST TRAJECTORY COLLECTION FOR MOBILE EDGE DEVICES

(71) Applicant: Dell Products L.P., Round Rock, TX (US)

(72) Inventors: Paulo Abelha Ferreira, Rio de Janeiro (BR); Pablo Nascimento da Silva, Niteroi (BR); Vinicius Michel Gottin, Rio de Janeiro (BR)

(21) Appl. No.: 17/812,910

(22) Filed: Jul. 15, 2022

(51) Int. Cl. G06N 7/00; G06K 9/62

(52) U.S. Cl. CPC G06N 7/005; G06K 9/6265; G06K 9/6256

(57) ABSTRACT

Active learning for collecting data for retraining machine learning models is disclosed. The performance of models deployed in multiple locations is monitored. When the aggregate error exceeds a threshold, a collection protocol is performed to identify the location with a highest uncertainty. Training samples are collected at least from the location with the highest uncertainty and used to retrain and redeploy the model to the nodes in the multiple locations.

### RELATED APPLICATIONS

This application is related to U.S. Ser. No. 17/585,055 filed Jan. 26, 2022, and to U.S. Ser. No. 17/663,423 filed May 14, 2022, which applications are incorporated by reference in their entirety.

### FIELD OF THE INVENTION

Embodiments of the present invention generally relate to active learning in logistics and event detection. More particularly, at least some embodiments of the invention relate to systems, hardware, software, computer-readable media, and methods for performing active learning for event detection in environments that include multiple objects.

### BACKGROUND

Logistics in environments such as a warehouse can be difficult to monitor and manage at least because many different objects in the environment may exist and/or operate simultaneously. Many of the objects in the warehouse, for example, are autonomous and mobile in nature while other objects are stationary or fixed. As a result, care should be exercised to ensure that accidents or other problems do not occur. This can be difficult as many of the objects operate concurrently, and their relative positions may not be known to each other. In essence, all objects in an environment, whether mobile or stationary, may be a hazard from the perspective of each object. Consequently, it is difficult to coordinate the movement of multiple objects and ensure that undesirable interactions do not occur.

In addition to the dangers associated with other objects, objects may experience dangerous events without interacting with other objects. Objects such as forklifts and mobile automated robots perform various mobile maneuvers for various reasons including the layout of the warehouse, the location of product, or the like. These objects, if driven or maneuvered in an unsafe manner, may experience a dangerous event. Dangerous events may include turning too sharply, turning while driving at an excessive speed, or turning too close to a hazard. The ability to improve the autonomy of mobile objects would improve the operation and efficiencies of logistical operations in these environments.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1 discloses aspects of a central node, edge nodes, and nodes associated with multiple locations or environments;

FIG. 2 discloses aspects of event detection at a node at a location;

FIG. 3 discloses aspects of an autoencoder, which is an example of a machine learning model;

FIG. 4 discloses aspects of active learning to maintain or update models distributed to nodes in multiple locations;

FIG. 5 discloses additional aspects of active learning;

FIG. 6 discloses aspects of performing active learning; and

FIG. 7 discloses aspects of a computing device, system, or entity.

### DETAILED DESCRIPTION OF SOME EXAMPLE EMBODIMENTS

Embodiments of the present invention generally relate to active learning in logistics and event detection. More particularly, at least some embodiments of the invention relate to systems, hardware, software, computer-readable media, and methods for active learning, logistics, and/or event detection in environments that include mobile objects.

An environment, such as a warehouse, may include mobile objects, movable objects, and/or stationary or static objects. These objects may include or be associated with sensors of varying types that generate data. The data may be analyzed to detect events and/or to perform actions upon detecting an event. For example, the data (or features thereof) may be input to a machine learning model. Actions performed at or by the object may depend on the inference or output of the machine learning model.

The data generated by the sensors can be used to perform logistics operations, which include by way of example and not limitation, active learning operations, event detection operations, cornering detection operations, tracking operations, trajectory prediction operations, trajectory operations, alerting/warning operations, positioning operations, management operations, or the like or combination thereof. The logistics and logistics operations disclosed herein, which may include or may benefit from active learning operations, which are based on sensor data generated at edge nodes in an edge environment or, more specifically, based on errors in the outputs of machine learning models.

Embodiments of the invention are discussed in the context of mobile objects operating in a warehouse. Mobile objects may include, but are not limited to, forklifts (manual or automated) autonomous mobile robots or vehicles, automatic guided vehicles, mobile machines capable of being driven/pulled/pushed/moved, and the like. Embodiments may relate to mobile devices or vehicles operating in, byway of example, manufacturing, retail, and other environments.

When performing logistics operations, a machine learning model (model) receives data (or features) as input and outputs, by way of example, an inference. Before deploying the model, the model is trained. Training the model uses data that collected from objects in one or more environments. After collecting a sufficient amount of data (e.g., position data, trajectory data, inertial data, and/or other sensor data), the model is trained using the collected data. Once trained, the model can be deployed to the mobile objects. Once deployed, data generated by the sensors is input into the model. The inference or output of the model may be indicative of an event such as a dangerous cornering event. The action that is triggered or caused by the inference may be to slow down, generate a warning or alert, or the like.

The model may be deployed to multiple different environments, also referred to as locations. Maintaining the model in a single environment and/or in multiple environments is challenging because the trajectories of objects in one environment may change and the trajectories of objects in one environment may be different from the trajectories of objects in another environment. The ability of the m model to predict an event depends, in part, on the training data. If the training data is insufficient, errors are likely to occur. Data collection, however, can be expensive and burdensome due to the resources required to collect the data. Storing large amounts of data that may be needed to train the machine learning model may not be feasible, even if possible. Also, asking the user for more data (e.g., when the model needs to be retrained or updated) is a high-friction, high-cost process when the goal is to make logistics automatic, competitive, and frictionless.

Embodiments of the invention include maintaining and/or updating models based on active learning. Active learning allows data to be collected in a manner that is more likely to improve the model at the lowest or at least a lower cost. Active learning allows data to be collected while reducing the burden of colleting the data on the user. This may include selecting the time and/or location of data collection.

More specifically, embodiments of the invention may monitor the performance of models in an environment or the performance of models in multiple environments. When the performance of the models declines or when the error is greater than a threshold error level, sample data may be collected from each object, each location, or the like or selected portions thereof.

The sample data is evaluated to determine an uncertainty. The data collected from each location may be considered separately such that the uncertainty of each location can be determined and compared. The uncertainty of the models at each location (each environment or each warehouse) is then determined from these collected samples. The location with the highest uncertainty (worst performance) is selected as the location from which to collect additional training data. This can reduce the burden associated with collecting data from all of the locations or environments while still improving the performance of the model at all locations or environments. In some example embodiments, training data may be collected from multiple locations. However, the amount of data collected at the worst performing location may be greater than the amount of data collected at other locations.

Embodiments of the invention are discussed in the context of machine learning and algorithmic models. Embodiments of the invention are also discussed with respect to the operation of automated mobile robots and/or forklifts (also referred to as nodes) in a warehouse environment. Embodiments of the invention can be applied to other objects (mobile devices, vehicles, or machines) in other environments.

Embodiments of the invention can be adapted to detect different types of events and/or to generating alerts and notifications. Embodiments may also perform automated operations such as generating notifications or alerts when an event is detected, cutting power to a device, or the like. Active learning can ensure that the models deployed to nodes in the environments can be maintained, updated, retrained, or the like.

Embodiments of the invention are achieved, in part, by equipping the objects in the environment with hardware such as sensors, processors, memory, networking hardware, or the like. In some examples, the objects may already be equipped with this type of hardware or portions thereof. The hardware may depend on the nature of the associated object. Mobile objects, for example, may be equipped with a different set of sensors compared to sensors or devices associated with a stationary or movable object. For example, hardware such as sensors, processors, memory, or the like may be integrated with a forklift or a mobile robot. A pallet, in contrast, may only have an RFID (Radio Frequency Identification) tag.

The hardware (and/or any software thereon) may be referred to as a node. However, reference to a node may also constitute a reference to the object associated with the node and on which the node is attached. Reference to an object, such as a forklift, may refer to the object and/or the node.

Nodes in the environment may communicate with a near edge node operating at a near-edge infrastructure and/or a central node operating in a datacenter. The central node is typically more computationally powerful than the near edge nodes and the near edge nodes are typically more computationally powerful than the nodes. Embodiments of the invention can be implemented with/without a central node, in which case the near edge node functions as a central node.

The sensors associated with a node may include position sensors and/or inertial sensors. The position and/or inertial sensors may generate data that allows movement to be detected, measured, or inferred. More specifically, the trajectory of a device can be determined or inferred. The model may be trained to recognize certain trajectories as dangerous or undesirable cornering events based on trajectories input to the model. Based on the inference, actions such as generating alerts, notifying operations, or the like. Other events may also be detected.

In some embodiments, the nodes may each have sufficient hardware (e.g., processor, memory, networking hardware) to process data generated by the node's sensors and/or data about other nodes that is broadcast by a central node, the near edge node, or by the other local nodes or other objects in the environment.

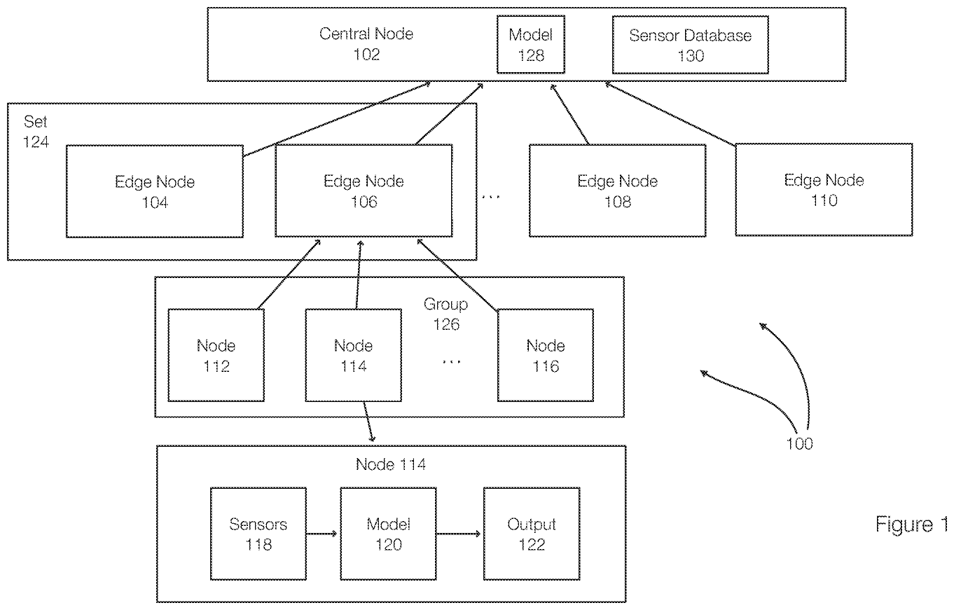

FIG. 1 discloses aspects of an environment in which embodiments of the invention may be deployed or implemented. FIG. 1 illustrates a system (e.g., a logistics system) 100 that includes a central node 102 (A) and edge nodes (N₀, . . . , Nₙ), represented by edge nodes 104, 106, 108, and 110. The edge nodes may be groups into collections or sets (C₀, . . . , C_{Z}) such as a set 124 which includes the edge nodes 104 and 106. The edge nodes 104, 106, 108, and 110 may be similar to the central node 102, but on a smaller scale in one example. For example, the set 124 may be associated with multiple warehouses and each of the edge node 104 and 106 is associated with a different warehouse. The central node 102 may have substantial storage and processing capabilities, particularly compared to the nodes 112, 114, and 116 in the group 126. The central node 102 and/or an edge node may handle orchestration and communication for certain nodes. The edge node 106, for example, may operate with respect to the group 126 of nodes.

Each of the edge nodes may associated with a set or group of nodes (E₀^{j}, . . . , Eᵢ^{j}) associated with an edge node Nⱼ. For example, the edge node 106 (Nⱼ) is associated with a group 126, represented by the nodes 112, 114, and 116 (E₀^{j}, E₁^{j}, . . . , Eᵢ^{j}). In this example, forklifts or automated mobile robots (or the nodes thereon) may be examples of the nodes 112, 114, and 116.

The node 114 (E₁^{j}) is further illustrated as including sensors 118 and a model 120, which generates an inference or an output 122. The model 122 may be representative of multiple models. Each model may be able to detect a certain type of event using the same or similar input data from the sensors 118

The data generated by the sensors 118 may be stored as a sensor dataset Si. In some examples, the data generated by the sensors 118 is provided to the central node 102, which may also have a copy of the model 120, represented as model 128. The sensor database 130 may store sensor data received from all of the nodes in the various environments. Thus, the node 114 may store sensor data generated by the node 114. The edge node 106 may store sensor data generated by the node 112, 114, and 116. The sensor database 130 includes sensor data from all nodes associated with all of the edge nodes 104, 106, 108, and 110.

At the node 114, only the recently generated data is generally stored. Local data may be deleted after transmission to the central node 102. Inferences for a time t are generated using the most recent sensor data. When working with trajectories, the model 120 may include one or more collections of sensor data. For example, a trajectory may be inferred from three successive position and/or inertial samples. The output 122 (e.g., inference q) of the model 120 (M) may be used for decision making with little delay at the node 114.

Forklifts in a warehouse is an example use-case of embodiments of the invention. The model 120 may be an event detection model that has been trained and deployed to the nodes 112, 114, and 116. For example, the model 120 may be ay configured to detect cornering events in the trajectories of mobile devices at the far edge and generate an inference as to whether the cornering event is dangerous or safe. Dangerous cornering is an example of a real-time event detection. The model 120 can be used to signal alarms for forklift operators when the cornering event is dangerous.

Example sensors 118 include position sensors (at least one), and inertial sensors (at least one). The node 114 may include compute resources such as a processor, memory, networking hardware, or the like.

The central node 102 (e.g., implemented in a near edge infrastructure or in the cloud) may be configured to communicate with the node 114. The communication may occur via the edge node 106. The communication may be performed using radio devices through hardware such as a router or gateway or other devices (e.g., the edge node 106). The node 114 may also receive information from the central node 102 and use the information to perform various operations including logistics operations.

The sensors 118 may include position sensors and inertial sensors that generate positional data that determine a position or trajectory of an object in the environment. Positional data can be collected as time series data, which can be analyzed to determine a position of the forklift, a velocity of the forklift, a trajectory or direction or travel, a cornering, or the like. The inertial sensors allow acceleration and deceleration to be detected in multiple directions and axes.

In one example, a map of the environment is generated and may be stored at the central node 102 and/or at the edge nodes 104, 106, 108, and 110. The system may be configured to map the position data received from the nodes into a map of the environment. This allows the positions of all nodes (objects) to be determined with respect to each other and with respect to the environment.

The central node 102 may include a model 128 and a sensor database 130. The sensor database 130 may include a database for different sensor types. Thus, the sensor database 130 may include a position data database, an inertial database, and the like. In another example, the sensor database 130 may store all sensor data together and/or in a correlated form such that position data can be correlated to inertial data at least with respect to individual nodes and/or in time.

In one example, the local model 120 is trained at the central node 102 and deployed to the relevant nodes 112, 114, and 118. The local model 120 is trained using available (historical) positioning and/or inertial measurement data (and/or other sensor data, which may include video data). After training, the local model 120 may be deployed to the nodes. In one example, the models 120 and 128 are the same. One difference is that the local model 120 may operate using locally generated data at the node 114 as input while the model 128 may use data generated from multiple nodes in the multiple environments as input (e.g., the sensor data in the sensor database 130).

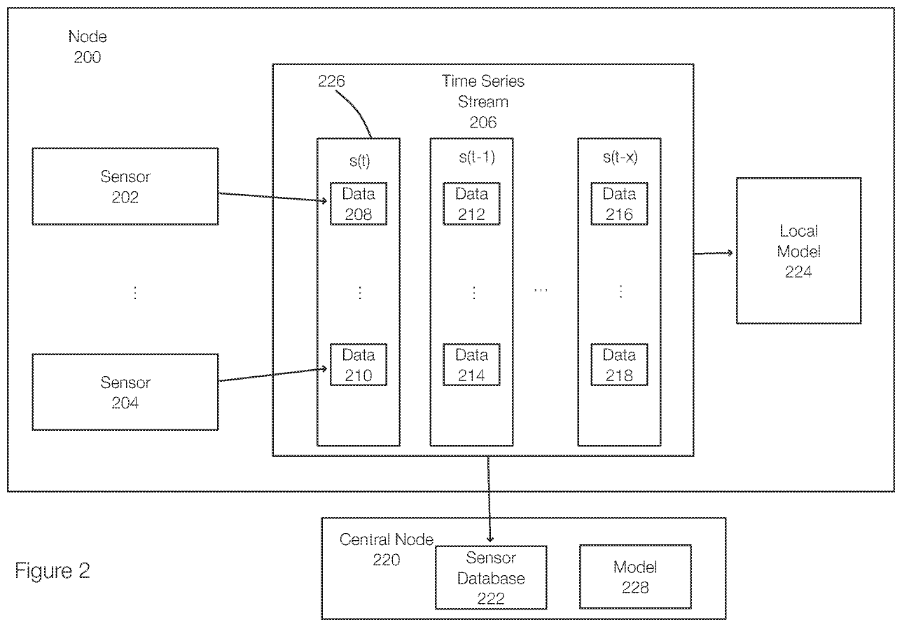

FIG. 2 discloses aspects of a node associated with or integrated with an object and configured to operate in an environment and perform logistics operations. The node 200, an example of the node 102, may include sensors, represented by sensors 202 and 204. In this example, the sensors 202 and 204 may include position sensors and/or inertial sensors.

The node 200 collects, over time, multiple readings from the sensors 202 and 204. The data generated by the sensors 202 and 204 may constitute a time series stream 206. For example, the stream 206 includes readings at different times and the data collected at a particular time may be referred to as a collection. Thus, the time series stream 206 may include multiple collections such as the collection 226.

The data 208 and 210 in the collection 226 were collected at time s(t), the data 212 and 214 were collected at time s(t−1), and the data 216 and 218 were collected at time s(t−x). Each of the nodes that includes sensors may generate a similar sensor data stream. Data generated from the sensors 202 and 204 may be collected periodically, whenever a change in a sensor's data is detected (e.g., acceleration or deceleration is detected), or the like or combination thereof. Data from the sensors 202 and 204 may be collected at different times. Further, the sensors 202 and 204 may be grouped by type (e.g., position sensors, acceleration or inertial sensors, temperature sensors) and each data from each type or from designated groups of sensors may be collected separately. In one example, there may be a time series stream for positional data, a time series stream for inertial data, or the like. Further, time series streams may be coordinated in time. A collection of inertial data may correspond to a collection of position data.

The data collected from the sensors 202 and 204 is associated with or includes position data that can be mapped into coordinates of the environment 100. Thus, for the collection of data associated with time s(t), a position p(t) is associated with the collection 226 of data. When collecting data from the sensors 202 and 204, the collection of data is typically correlated to a position in the environment. In addition to position data, sensors may also provide inertial measurements of acceleration and deceleration. Other data, for objects such as a forklift, may include mast position, load weight, or the like. The data collected from an object may depend on the object.

The time series stream 206 may be transmitted to a central node 220, which is an example of the central node 102, and stored in a sensor database 222 of or associated with the central node 220. Thus, the time series stream 206 is available for use by the local model 224 to generate inferences, such as whether a dangerous or undesirable event is occurring/has occurred. The time series data from all nodes is available to the model 228, which may perform the same or similar function as the local model 224 but may generate inferences based on data from multiple nodes from one environment or multiple environments.

The time series stream 206 may be collected periodically at the central node 220. This allows the central node 220 to store sensor data from each of the nodes in the sensor database 222. The central node 220 may store position/inertial data related to dynamic, mobile, and static nodes.

When detecting events such as cornering events, data including position data and inertial data (generally referred to as positional) may be collected. The position or positioning data may include GPS (Global Positioning System) data, RFID (Radio Frequency Identification) or WiFi triangulation data, or combination thereof. The inertial data may include inertial measurements of acceleration and deceleration. The inertial data may be obtained via inertial measurement unit (IMU) sensors. The positional data may be used to detect cornering events. More specifically, embodiments of the invention focus on aspects of the positional data that represent cornering or trajectories that represent cornerings. However, embodiments of the invention can be adapted to detect other events that are represented by the positional data or from other sensors that may correspond to other types of events.

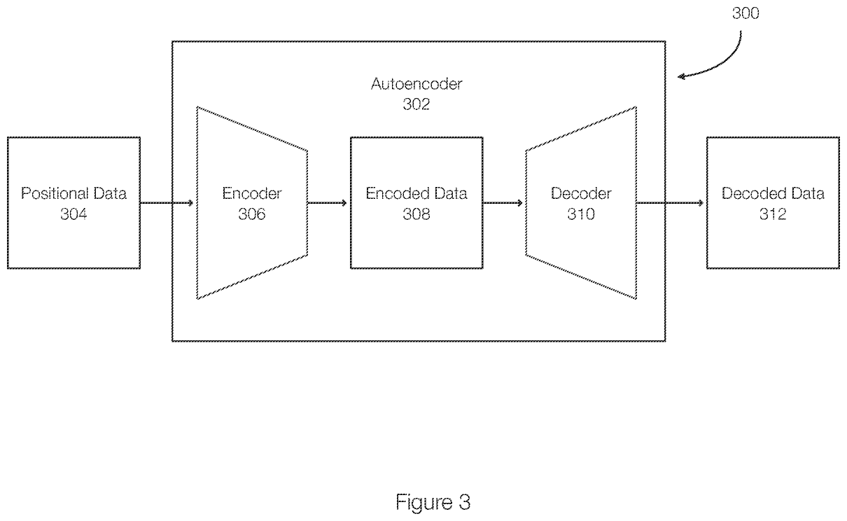

FIG. 3 discloses aspects of a model configured to identify or infer non-normative events, such as non-normative cornering events. In one example, the trained model 300 is an autoencoder model, represented by the autoencoder 302. In one example, the data set 304 (e.g., positional data) may be used to train the autoencoder 302. More specifically, the positional data 304 may include cornering data such that cornering events can be detected. The autoencoder 302 is often unsupervised and learns to encode/decode data. In effect, the encoder 306 may compress the positional data 304 into compressed or encoded data 308. The decoder 310 operates to decompress or decode the encoded data 308. Ideally, the decoded data 312 is the same as the input data 304. Each datum Xᵢ(e.g., cornering event data) input into the encoder 302 generates a latent vector Zᵢ(encoded data 308) that, when passed through the decoder 310 generates a decompressed datum Xᵢ′ (the decoded data 312). The encoder 306 may be represented as f_{θ}_{ₑ}(x) and the decoder 310 may be represented as f_{θ}_{_{d}}(z). In this formulation, θ represents or determines the parameterization where θₑ refers to the encoding parameters and θₑ refers to the decoding parameters.

Once the autoencoder 302 has been trained with the positional data 304, a reconstruction error (e.g., L1 loss) is determined for each sample in the training data set (e.g., the data 304). This can provide an error estimation for typical or normal cornering events, which were used to train the autoencoder model 302. In one example, the positional data 304 used to train the autoencoder 302 does not include non-normative data. Thus, data corresponding to dangerous cornering events is not used to train the autoencoder such that dangerous or non-normative cornering events can be identified using the loss.

The autoencoder 302, or other model, may be trained at the central node 220. In this example, data is collected from the objects (e.g., the nodes or forklifts or robots). The data may include positioning data, inertial data, and/or contextual data. Cornering events are identified from the data to obtain a dataset of cornering events. Next, a model, such as the autoencoder model 302, is trained using the cornering events such that the autoencoder is capable of reconstructing the cornering events.

Because of the data checks performed on the data, the training data set is expected to include normative behavior such that dangerous cornering events are not considered as normal events by the model 302.

After the model 302 is trained at the central node, the model 302 is deployed to a local node. An inference pipeline may be implemented at the local node. Generally, sensor data is generated at the local node. In effect, the data generated at the local node is streamed or collected in real time at the local node. In one example, checks and transformations may be applied to the data generated at the local node. A cornering event may be detected, for example, as previously described.

When a cornering event is detected, the corresponding data is input to the model, which infers a type of cornering event. More specifically, the L1 loss for the data of the cornering event 316 input to the model is determined. If the loss L1 is greater than a normative reconstruction error threshold, the cornering event is determined or inferred to be a dangerous cornering event or determined to be non-normative, at least compared to the training positional data 304.

The inference is performed at the local nodes in the environment after the model and other information such as the mean and standard deviation of the training reconstruction error, are deployed to the local nodes.

Advantageously, event detection as disclosed herein is not dependent on dangerous cornering supervised data. As previously stated, an autoencoder neural network does not rely on supervised training in one embodiment and embodiments of the invention do not require labeled data.

FIGS. 1, 2 and 3 illustrate that a central node can communicate with several near edge nodes and that each of the near edge nodes may communicate with associated nodes. In one example, the nodes may communicate with a central node directly. As previously stated, it is beneficial to maintain and/or update the models that have been deployed to the nodes. Although the model (e.g., the autoencoder) can be trained continuously as additional positional data is generated at the nodes and provided to the central node, this may introduce complexity and cost due to the burden associated with collecting, storing, and/or transmitting the collected data. Collecting data requires the mobile objects to devote processing time to collecting and/or processing the data.

Embodiments of the invention focus on maintaining the model by reducing or minimizing the data that needs to be collected. An active learning framework is provided that allows data needed to improve or maintain the model to be collected selectively and in a more precise manner that maximizes data usefulness.

Generally, the model deployed to nodes in multiple environments is monitored for performance. When the performance of the models drops below a threshold performance, the central node communicates with all locations (e.g., the edge nodes N) and/or nodes (e.g., the nodes E) to start a collection operation. A relatively small set of samples are collected from each location. The data collected in the collection operation are not necessarily used for training the model but are used for an uncertainty operation and active learning.

The central node aggregates the samples, by location, and performs an uncertainty operation. In one example, the uncertainty operation includes a Bayesian deep learning model. Even if machine learning models can generate useful inferences, these models do not necessarily capture the uncertainty of the model. The loss of the model is distinct from, though related to, the uncertainty. To determine the model uncertainty, a Bayesian approximation may be performed. The distribution over a model's predictions can be approximated by performing random trials that use less than all of the model's neurons. This is an example of performing dropout trials. In this case, a given number of neurons are randomly omitted in each trial and the neural network's outputs are collected for each trial.

Once the outputs of each trial have been collected, the mean of the distribution can be approximated as the mean response from the model and the standard deviation is determined as the standard deviation of the model responses. This allows the location (edge node or environment) or the model that has the highest uncertainty to be identified—the one with the largest standard deviation. Stated differently, the identified location may have events that were not part of the original training data. As a result, the reconstruction error is higher even though these events may be normal. Identifying the location with the highest uncertainty allows the model to be trailed with additional data that will improve the operation of the model.

Active learning leverages the uncertainty operation to identify the edge node whose data is likely to be most beneficial for improving the model performance. Training data can then be collected from that location and there may be no need to collect training data from the other locations (although some data may be collected from each of the locations). Embodiments of the invention maximize diversity to improve training.

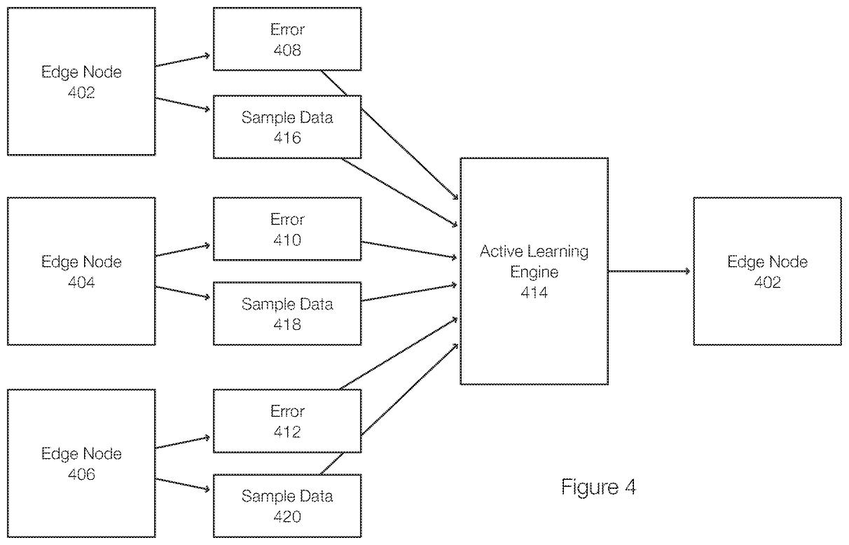

FIG. 4 discloses aspects of active learning. In FIG. 4, an active learning engine 414, typically deployed at the central node, receives errors (error 408, 410, and 412) from the edge nodes 402, 404, and 406. The errors 408, 410, and 412 include reconstruction errors of the models. The active learning engine 414 may process the errors 408, 410, and 412 evaluates the errors 408, 410, and 412. When the overall error is above a threshold error, a collection operation is performed. Sample data 416, 418, and 420 is collected from each location (each of the nodes associated with the edge nodes 402, 404, and 406) and an uncertainty operation is performed using the sample data 416, 418, and 420. The uncertainty operation identifies the edge node that has the highest uncertainty, which is the edge node 402 in this example. Once the edge node 402 is identified from the uncertainty operations, training data is then collected at least from the edge node 402

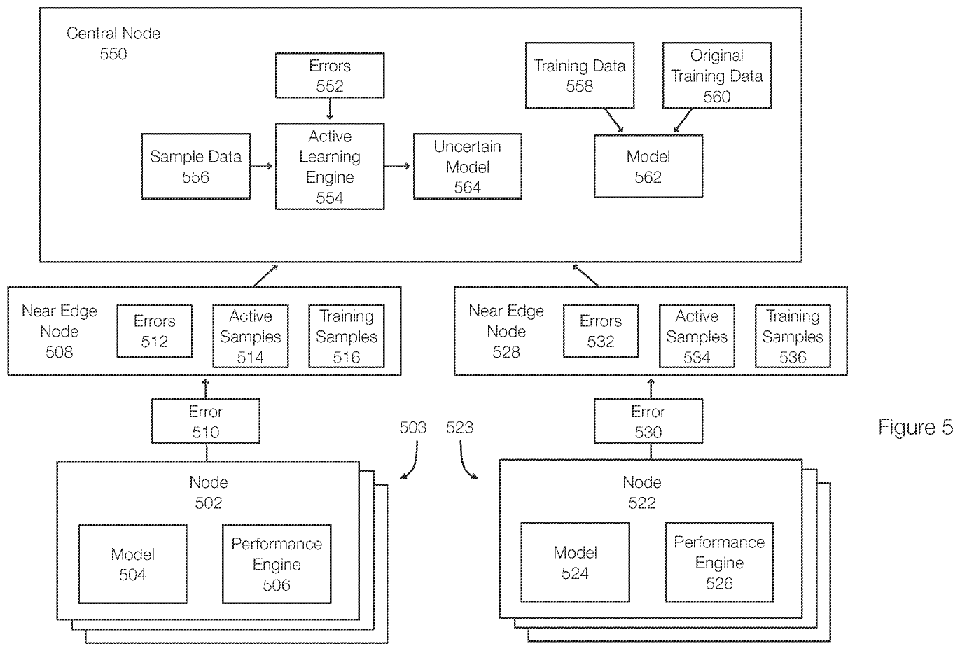

FIG. 5 discloses aspects of active learning to maintain or update machine learning models. FIG. 5 illustrates a central node 550. Near edge nodes are represented by the near edge nodes 508 and 528. The near edge node 508 associated with nodes 503 and the near edge node 528 is associated with the nodes 523.

During operation of the node 502, the model 504 may use positional data generated at the node 502 to output inferences. A performance engine 506 may be configured to monitor the performance of the model 504. For example, if the model 504 is an autoencoder, the performance engine 506 may keep track of the reconstruction error output for each trajectory sample, which may include a plurality of positional samples. This error 510 may be stored locally at the node 502 if storage is sufficient and/or provided to the near edge node 508. More specifically, the near edge node 508 may collect errors 512, which correspond to the reconstruction errors of the nodes 503. Similarly, the performance engine 526 of the node 522 monitors the performance of the model 524. The error 530 is sent to the near edge node 528, which stores the errors 532 of the nodes 523.

The near edge node 508 may provide the errors 512 to the central node 550 and the near edge node 528 provides the errors 532 to the central node 550. The errors 552 represent the reconstruction errors from each of the near edge nodes 508 and 528. The errors 552 are organized or identified such that the central node 550 knows, at a minimum, which near edge node provide which errors. This allows the central node 550 to operate on the errors 510 separately and independently of the errors 532.

The active learning engine 554 may determine an aggregate performance error for all of the near edge nodes based on the errors 552. When the aggregate performance error is above a threshold performance error, the active learning engine 554 may trigger a collection operation or perform a data collection protocol.

When the data collection protocol is triggered, the central node 550 may send a signal to each of the near edge nodes 508 and 528, which propagate the signal to the nodes 503 and 523. The signal initiates a data collection operation at the nodes 503 and 523. The data collection operation is typically performed for a specified amount of time and in a way to maximize variability. For example, positional data such as trajectory data may be collected all at once, at different times, in a spaced-out manner, or the like. Further, the manner in which data is collected at the nodes 503 and 523 may vary from node to node and from location to location.

The near edge nodes 508 and 528 receive the collected data, represented by the active samples 514 and 534. The active samples 514 and 534 are provided to the central node 550 and stored as sample data 556. The amount of data included in the sample data 556 is small (compared to the original training data 560) at least because one purpose of the sample data 556 is to determine model uncertainty rather than train the models 504 and 524.

The sample data 556 may be labeled for use in active learning. Once sufficient sample data 556 is collected from all of the near edge nodes 508 and 528, the active learning engine 554 performs active learning using the sample data 556. When performing the uncertainty operation, the model 504 (a copy of which is at the central node 550) is used. The sample data 556 may be separated into sets, where each set corresponds to one of the near edge nodes 508 and 528. In this example, there are two sets of sample data 556, but the number of sets may depend on the number of near edge nodes.

In this example, Bayesian Deep learning, or other uncertainty determination scheme, is used to determine a standard deviation for each of the near edge nodes 508 and 528. The active learning engine 554 performs Bayesian deep learning on each set of sample data 556. The near edge node with the highest standard deviation is selected and additional data is collected from that specific near edge node or from the nodes associated with than near edge node. The near edge node with the highest standard deviation is typically the near edge node for which the model has the highest uncertainty, which indicates that data gathered from this node is most likely to help improve model performance overall.

Once the edge node with highest uncertainty is identified (e.g., the near edge node 528) data samples for training purposes are collected from the selected near edge node 528 or, more specifically, from the nodes 523. In some embodiments, a smaller number of data training samples may be collected from each of the other near edge nodes 508. The training samples 516 are collected from the nodes 503 and the training samples 536 are collected from the nodes 523. The training samples 516 and 536 are aggregated as the training data 558 at the central node.

The model 562 is then retrained using the training data 520 and the original training data 560. Once the model 562 is trained, the model 562 is deployed to the nodes 503 and 523. Thus, the updated or newly trained model 562 replaces the model 504 and the model 524.

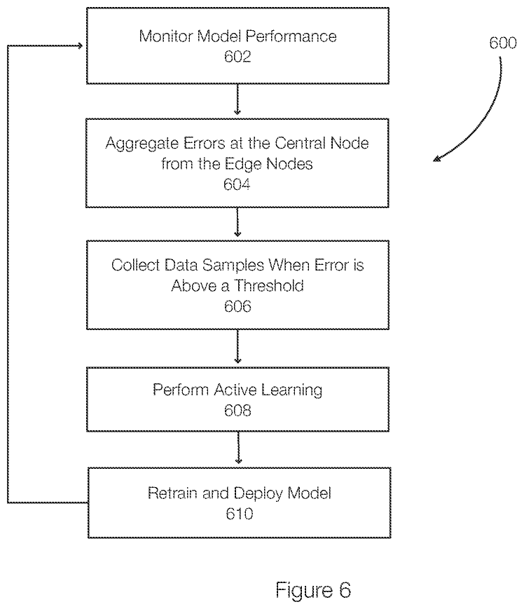

FIG. 6 discloses aspects of performing active learning in nodes in different locations or environments. The method 600 may start by monitoring 602 a performance of a machine learning model. The performance is a reflection of the reconstruction loss. A higher reconstruction loss corresponds to poorer performance. The models at each node in each location or environment may be monitored at the node.

The errors measured or monitored at the nodes are aggregated 604 at the central node. Thus, each node may transmit their error to a near edge node, which then transmits the errors to the central node. Part of aggregating 604 the errors may include monitoring an aggregate performance. When the aggregate performance or error exceeds a threshold error level, a data collection protocol is triggered.

In this example, data samples are collected 606 from each of the nodes in each of the locations. Active learning is performed 608 on the collected data samples. More specifically, the data samples from each near edge node are evaluated using Bayesian deep learning or using another method to determine the model's uncertainty. Performing 608 active learning includes identifying or determining the near edge node that has the highest uncertainty. Once near edge node is identified, active learning 606 includes collecting training samples from the nodes associated with the near edge node with the highest uncertainty. A smaller number of training samples may also be collected from the nodes of the other near edge nodes.

Once sufficient training data is collected, the model is retrained and redeployed 610 to the nodes in all locations. Retraining the model is performed using a combination of the newly collected training samples and the original training data.

In one example, the central node may have a database of models and data sets. The central node can select the model currently deployed at the nodes and identify the data set used to train that model. The newly acquired training data is mixed with the original data to remove bias in optimization, and the model is retrained and deployed. The method 600 may then repeat.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, logistics and logistics-related operations which may include, but are not limited to, active learning operations, data collection operations, statistical operations, Bayesian operations, or the like. More generally, the scope of the invention embraces any operating environment in which the disclosed concepts may be useful.

New and/or modified data collected and/or generated in connection with some embodiments, may be stored in a data environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to service read, write, delete, backup, restore, and/or cloning, operations initiated by one or more clients or other elements of the operating environment.

Example cloud computing environments, which may or may not be public, include storage environments that may provide data storage functionality, function functionality, model training functionality for one or more clients. Another example of a cloud computing environment is one in which processing, data protection, model training, and other, services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients (e.g., objects or devices) that are capable of collecting, modifying, and creating, data. As such, a particular client may employ, or otherwise be associated with, one or more instances of each of one or more applications that perform such operations with respect to data. Such clients may comprise physical machines, containers, or virtual machines (VM).

Particularly, devices in the operating environment may take the form of software, physical machines, containers, or VMs, or any combination of these, though no particular device implementation or configuration is required for any embodiment.

Example embodiments of the invention are applicable to any system capable of storing and handling various types of objects, in analog, digital, or other form.

It is noted that any of the disclosed processes, operations, methods, and/or any portion of any of these, may be performed in response to, as a result of, and/or, based upon, the performance of any preceding process(es), methods, and/or, operations. Correspondingly, performance of one or more processes, for example, may be a predicate or trigger to subsequent performance of one or more additional processes, operations, and/or methods. Thus, for example, the various processes that may make up a method may be linked together or otherwise associated with each other by way of relations such as the examples just noted. Finally, and while it is not required, the individual processes that make up the various example methods disclosed herein are, in some embodiments, performed in the specific sequence recited in those examples. In other embodiments, the individual processes that make up a disclosed method may be performed in a sequence other than the specific sequence recited.

Following are some further example embodiments of the invention. These are presented only by way of example and are not intended to limit the scope of the invention in any way.

Embodiment 1. A method comprising: monitoring performance of a model deployed on nodes in a first location, sending errors of the nodes to a central node, wherein the central node receives errors of nodes in other locations, wherein errors from all of the locations are stored as aggregate errors, collecting sample data when an error of the aggregate errors exceeds a threshold error level, performing an uncertainty operation using the sample data to identify a near edge node with a highest uncertainty, collecting training data from nodes associated with the near edge node, and retraining the model using at least the collected training data.

Embodiment 2. The method of embodiment 1, wherein the performance is a reconstruction loss of the model, wherein higher reconstruction losses correspond to poorer performance.

Embodiment 3. The method of embodiment 1 and/or 2, wherein performing the uncertainty operation comprises performing the uncertainty operation on each set of the sample data, wherein each set of the sample data corresponds to one of the locations.

Embodiment 4. The method of embodiment 1, 2, and/or 3, wherein the uncertainty operation includes a Bayesian deep learning, wherein the Bayesian deep learning includes dropping different neurons from the model for each trial run in a set of trial runs for the set of sample data.

Embodiment 5. The method of embodiment 1, 2, 3, and/or 4, wherein the uncertainty operation generates a standard deviation for each set of the sample data.

Embodiment 6. The method of embodiment 1, 2, 3, 4, and/or 5, wherein the near edge node with the highest uncertainty corresponds to the set of the sample data associated with a highest standard deviation.

Embodiment 7. The method of embodiment 1, 2, 3, 4, 5, and/or 6, further comprising collecting a smaller amount of training data from nodes of other near edge nodes associated with the other locations, wherein the smaller amount of training data is included in the collected data.

Embodiment 8. The method of embodiment 1, 2, 3, 4, 5, 6, and/or 7, further wherein the central node is configured to store the collected data.

Embodiment 9. The method of embodiment 1, 2, 3, 4, 5, 6, 7, and/or 8, further comprising retraining the model using the new training data and original training data used previously to train the model to generate a new model.

Embodiment 10. The method of embodiment 1, 2, 3, 4, 5, 6. 7. 8. and/or 9, wherein the central node is configured to deploy the new model to all nodes in all of the locations.

Embodiment 11. A method for performing any of the operations, methods, or processes, or any portion of any of these, or any combination thereof, disclosed herein.

Embodiment 12. A non-transitory storage medium having stored therein instructions that are executable by one or more hardware processors to perform operations comprising the operations of any one or more of embodiments 1-11.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general-purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machines may reside and operate in a cloud environment.

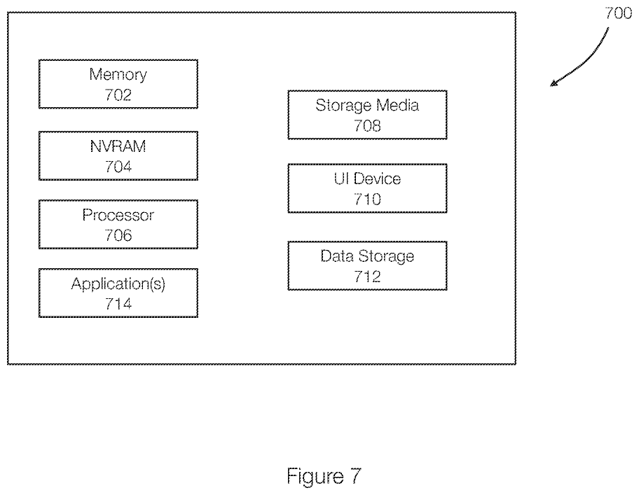

With reference briefly now to FIG. 7, any one or more of the entities disclosed, or implied, by the Figures, and/or elsewhere herein, may take the form of, or include, or be implemented on, or hosted by, a physical computing device, one example of which is denoted at 700. As well, where any of the aforementioned elements comprise or consist of a virtual machine (VM), that VM may constitute a virtualization of any combination of the physical components disclosed in FIG. 7.

In the example of FIG. 7, the physical computing device 700 includes a memory 702 which may include one, some, or all, of random access memory (RAM), non-volatile memory (NVM) 704 such as NVRAM for example, read-only memory (ROM), and persistent memory, one or more hardware processors 706, non-transitory storage media 708, UI device 710, and data storage 712. One or more of the memory components 702 of the physical computing device 700 may take the form of solid-state device (SSD) storage. As well, one or more applications 714 may be provided that comprise instructions executable by one or more hardware processors 706 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
monitoring performance of a model deployed on nodes in a first location;
sending errors of the nodes to a central node, wherein the central node receives errors of nodes in other locations, wherein errors from all of the locations are stored as aggregate errors;
collecting sample data when an error of the aggregate errors exceeds a threshold error level;
performing an uncertainty operation using the sample data to identify a near edge node with a highest uncertainty;
collecting training data from nodes associated with the near edge node; and
retraining the model using at least the collected training data.

2. The method of claim 1, wherein the performance is a reconstruction loss of the model, wherein higher reconstruction losses correspond to poorer performance.

3. The method of claim 1, wherein performing the uncertainty operation comprises performing the uncertainty operation on each set of the sample data, wherein each set of the sample data corresponds to one of the locations.

4. The method of claim 3, wherein the uncertainty operation includes a Bayesian deep learning, wherein the Bayesian deep learning includes dropping different neurons from the model for each trial run in a set of trial runs for the set of sample data.

5. The method of claim 3, wherein the uncertainty operation generates a standard deviation for each set of the sample data.

6. The method of claim 5, wherein the near edge node with the highest uncertainty corresponds to the set of the sample data associated with a highest standard deviation.

7. The method of claim 1, further comprising collecting a smaller amount of training data from nodes of other near edge nodes associated with the other locations, wherein the smaller amount of training data is included in the collected data.

8. The method of claim 7, wherein the central node is configured to store the collected data.

9. The method of claim 8, further comprising retraining the model using the new training data and original training data used previously to train the model to generate a new model.

10. The method of claim 9, wherein the central node is configured to deploy the new model to all nodes in all of the locations.

11. A non-transitory storage medium having stored therein instructions that are executable by one or more hardware processors to perform operations comprising:
monitoring performance of a model deployed on nodes in a first location;
sending errors of the nodes to a central node, wherein the central node receives errors of nodes in other locations, wherein errors from all of the locations are stored as aggregate errors;
collecting sample data when an error of the aggregate errors exceeds a threshold error level;
performing an uncertainty operation using the sample data to identify a near edge node with a highest uncertainty;
collecting training data from nodes associated with the near edge node; and
retraining the model using at least the collected training data.

12. The non-transitory storage medium of claim 11, wherein the performance is a reconstruction loss of the model, wherein higher reconstruction losses correspond to poorer performance.

13. The non-transitory storage medium of claim 11, wherein performing the uncertainty operation comprises performing the uncertainty operation on each set of the sample data, wherein each set of the sample data corresponds to one of the locations.

14. The non-transitory storage medium of claim 13, wherein the uncertainty operation includes a Bayesian deep learning, wherein the Bayesian deep learning includes dropping different neurons from the model for each trial run in a set of trial runs for the set of sample data.

15. The non-transitory storage medium of claim 13, wherein the uncertainty operation generates a standard deviation for each set of the sample data.

16. The non-transitory storage medium of claim 15, wherein the near edge node with the highest uncertainty corresponds to the set of the sample data associated with a highest standard deviation.

17. The non-transitory storage medium of claim 11, further comprising collecting a smaller amount of training data from nodes of other near edge nodes associated with the other locations, wherein the smaller amount of training data is included in the collected data.

18. The non-transitory storage medium of claim 17, wherein the central node is configured to store the collected data.

19. The non-transitory storage medium of claim 18, further comprising retraining the model using the new training data and original training data used previously to train the model to generate a new model.

20. The non-transitory storage medium of claim 19, wherein the central node is configured to deploy the new model to all nodes in all of the locations.
